(19) United States
(12) Patent Application Publication
(10) Pub. No.: US 2018/0242769 A1
(43) Pub. Date: Aug. 30, 2018

(54) JUICING BAG

(71) Applicant: Shanghai Aiwei Electronic Technology Co., Ltd., Shanghai (CN)

(72) Inventors: Xiuxing CHEN, Shanghai (CN); Zechen Yang, Shanghai (CN)

(21) Appl. No.: 15/548,085

(22) PCT Filed: Jul. 21, 2017
(86) PCT No.: PCT/CN2017/093762

§ 371 Date: Aug. 1, 2017

(30) Foreign Application Priority Data
Sep. 14, 2016 (CN) 201610822790.0

(51) Int. Cl. A47J 19/02

(52) U.S. Cl. CPC A47J 19/02

(57) ABSTRACT

A juicing bag comprises an outer bag, an inner filter bag and a sealing strip. The outer bag includes a juice outlet associated with the bottom end of the outer bag and a sealing strip associated with the top end of the outer bag. The inner filter bag can be placed in the outer bag. The sealing strip facilitates putting fruit into the juicing bag and also seals the juicing bag to prevent juice from sputtering. The juicing bag also include a leak-proof seal configured to prevent liquid from flowing out of the juicing bag before juicing begins. It also includes a diversion line configured to divert the juice to the side to prevent the juice from flushing out of the juicing bag. The juicing bag further includes hang holes and a weight hang hole to facilitate putting fruit into the juicing bag and weighing the fruit.

### CROSS-REFERENCE TO RELATED APPLICATION

This application claims priority to Chinese Patent Application Serial No. 201610822790.0, “Juicing Bag,” filed on Sep. 14, 2016. The subject matter of all of the foregoing is incorporated herein by reference in their entirety.

### BACKGROUND

### 1. Field of the Invention

The present disclosure relates to juicing, in particular to a juicing bag.

### 2. Description of Related Art

In modern life, more and more people want to get needed nutrients through their diet. However, for people who have dietary bias or are poor in body function, they often choose to get nutrients by drinking juice. Therefore, juicers are being used more frequently.

Existing juicers include centrifugal juicers, grinding-type juicers and squeezing-type juicers. For most of the existing juicers, juice is left in the juicers after the juicing. If a juicer is not cleaned in time, bacteria will accumulate in the juicer, which affects future use. Moreover, when a juicer has been used for juicing a particular type of fruit, the juicer can have odor from that type of fruit, making a user uncomfortable to use the juicer for a different type of fruit. Therefore, it is necessary to clean the existing juicers after each use. Cleaning those juicers is usually time-consuming and labor-consuming, which causes a certain burden to the user and goes against existing fast-paced lifestyle. Although there are disposable filter bags, it is troublesome to put fruit into these filter bags. For these filter bags, it is difficult to quickly add a proper amount of fruit according to needs of the user. Instead, fruit is weighed by other devices and then put into the filter bag. The process is complicated. Moreover, juice outlet of those filter bags directly connect to outside, and juice can easily sputter. Further, there is no leak-proof setting, so that at the time of adding fruit, liquid with the fruit can flow out from the juice outlet, which affects the normal juicing process.

In conclusion, the existing juicing devices are problematic because they require cleaning after use, easily get tainted by odor of juice, have the problem of juice sputtering during juicing and juice leaking before juicing.

### SUMMARY

The present disclosure overcomes the limitation of prior art by using a juicing bag that includes an outer bag and an inner filter bag to avoid clean of juicers. The inner filter bag is enclosed in the outer bag. The juicing bag further includes a juice outlet associated with an end of the outer bag and a diversion line between the inner filter bag and the juice outlet. The juice outlet allows juice to flow out from the juicing bag. The diversion line is associated with the outer bag and configured to prevent the juice from sputtering. The juicing bag also includes a leak-proof seal between the diversion line and the juice outlet. The leak-proof seal seals the juice outlet and can prevent leaking of liquid from the juicing bag before juicing begins.

In one implementation, the outer bag includes two layers: a front layer and a back layer. The edges of the outer bag are seal welded. In some embodiments, the outer bag is made of a food-grade, waterproof, pressure-resistant and sealable material.

The inner filter bag is between the top section and the bottom section of the outer bag. The inner filter bag has a cross-section in U-shape. The bottom of the cross-section of the inner filter bag faces the juice outlet. In one embodiment, a top edge and both side edges of the inner filter bag are seal-welded with an inner wall of the outer bag. In another embodiment, both side edges and a bottom edge of the inner filter bag are each independently seal-welded. The inner filter bag is detachable. In some embodiments, the inner filter bag is made of a food-grade filter layer material.

The sealing strip is associated with the outer bag and is distant from the end of the outer bag that the juice outlet is associated with. The sealing strip can be opened and closed.

The juicing bag also includes hang holes on an end of the outer bag that is distant from the juice outlet. In one embodiment, one of the hang holes is racetrack shaped, and the other hang holes are round. In some embodiments, the juicing bag further includes weight hang holes on the end of the outer bag.

In some embodiments, the leak-proof seal is associated with a pressure limit. The leak-proof seal opens when it is under a pressure not lower than the pressure limit. Likewise, the leak-proof seal is closed when it is under no pressure or under a pressure lower than the pressure limit.

The juicing bag may have some of the following advantages. The combination of the outer bag and inner filter bag is used to complete juicing and filtering, which will not contaminate the juicer during juicing and achieves the cleaning-free effect. Hang holes are provided in the outer bag, so that it is more convenient to put fruit into the juicing bag. A weight hang hole is provided in the outer bag, which makes it convenient to weigh fruit and allows a user to know the weight of the fruits. The sealing strip makes it convenient to put in the fruit, and achieves a sealing effect during juicing to prevent sputtering of the juice. The diversion line is configured to guide squeezed juice in the inner filter bag to divert to both sides of the juicing bag and then to the juice outlet, which prevents too much juice directly flushing out of the juice outlet. The leak-proof seal cannot be opened at a pressure lower than the pressure limit, ensuring that liquid does not flow out of the juicing bag before juicing begins to affect the normal use of the juicer.

The juicing bag described above includes an outer bag that includes a front layer and a back layer. One end of the outer bag is associated with a juice outlet, and the other end of the outer bag is provided with a sealing strip. An inner filter bag is between the front layer and the back layer of the outer bag. A diversion line is between the inner filter bag and the juice outlet. And a leak-proof seal is between the diversion line and the juice outlet. Therefore, the structure design of the juicing bag is reasonable and its layout is compact. The combination of the outer bag and the inner filter bag is configured to juice and filter. It is ensured that the juicer is clean during the juicing. And cleaning of the juicer is avoided. It is convenient to add fruit or other types of food into the juicing bag through the sealing strip. Also, the sealing strip prevents juice sputtering during the juicing. The diversion line is configured to guide the juice to flow to the two sides of the juicing bag and then flow to the juice outlet, which prevents too much juice directly flushing out of the juice outlet. The leak-proof seal is configured to ensure that liquid does not flow out from the juicing bag before juicing begins to affect the normal use of the juicing device. Hang holes and a weight hang hole are further provided at one end of the outer bag that is distant from the juice outlet, which facilitates both adding and weighing food. The juicing bag is multi-functional.

### BRIEF DESCRIPTION OF THE DRAWINGS

FIG. 1 is a diagram of a juicing bag, in accordance with the invention.

FIG. 2 is a diagram showing a cross-section of the juicing bag, in accordance with the invention.

FIG. 3 is another diagram of the cross-section of the juicing bag, in accordance with the invention.

FIG. 4 is a diagram of another juicing bag, in accordance with the invention.

FIG. 5 is a diagram of an inner filter bag in the juicing bag in FIG. 4, in accordance with the invention.

In the drawings: 1. outer bag; 11. juice outlet; 12. hang hole; 13. weight hang hole; 2. inner filter bag; 21. upper edge welding part; 22. side edge welding part; 3. sealing strip; 4. diversion line; 5. leak-proof seal; 6. seal flap.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed. The following description uses fruit as an example food. But a juicing bag disclosed herein can be used for other types of food, such as vegetable.

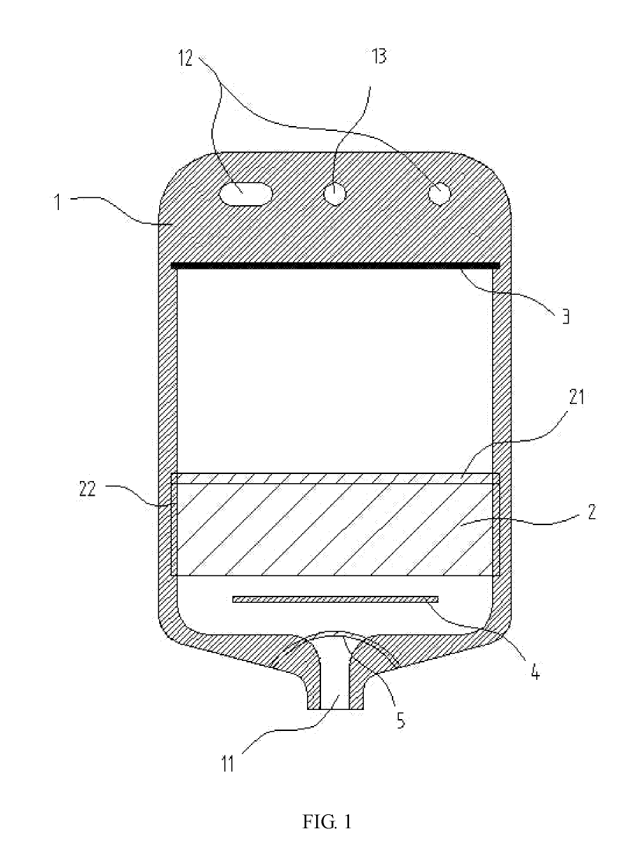

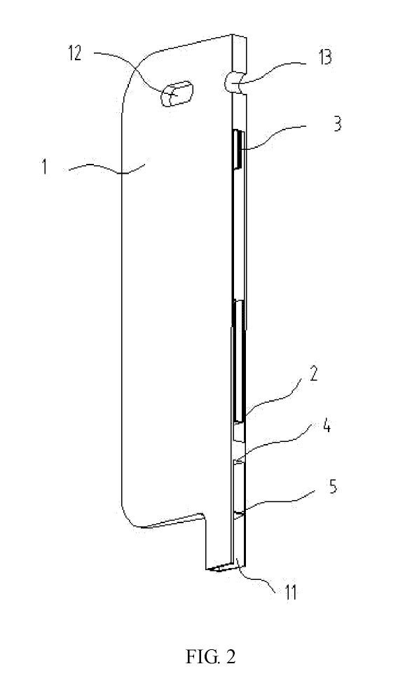

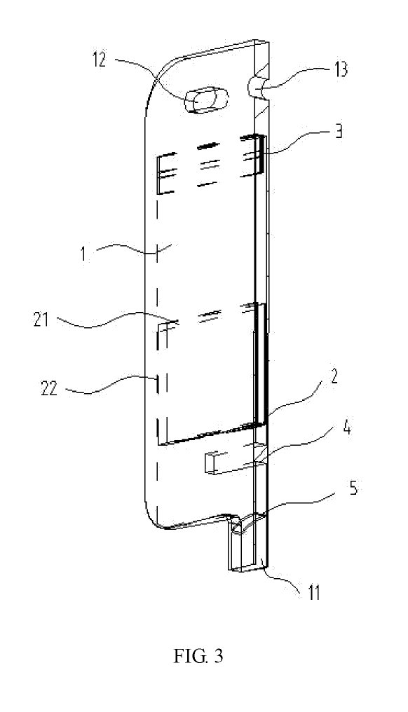

### Embodiment 1: Referring to FIG. 1, FIG. 2 and FIG. 3

FIG. 1 is a diagram of a juicing bag, in accordance with the invention. FIG. 2 is a diagram showing a cross-section of the juicing bag, in accordance with the invention. FIG. 3 is another diagram of the cross-section of the juicing bag, in accordance with the invention.

The juicing bag includes an outer bag 1, a juice outlet 11, hang holes 12, a weight hang hole 13, a sealing strip 3, an inner filter bag 2, a diversion line 4 and a leak-proof seal 5. In other embodiments, the juicing bag may include additional, fewer, or different components.

The outer bag 1 includes two layers (a front layer and a back layer). FIG. 1 shows the front layer. The periphery edges of the two layers of the outer bag 1 are connected together through seal-welding to form an approximately sealed cavity. The welded seal is shown by diagonal strip pattern in FIG. 1. The juice outlet 11 is associated with one end (i.e., the bottom) of the outer bag 1. It extends from the cavity to the outside, and allows juice to flow out from the juicing bag. The sealing strip 3 is associated with another end (e.g., the top) of the outer bag 1 and connects the cavity with the outside. The sealing strip 3 can be manually opened and closed quickly, allowing a user to quickly put the ingredients into the bag and quickly seal the bag. Accordingly, the juice will not sputter out during juicing and the user does not have to clean the juicer.

Moreover, the weight hang hole 13 is at the welded area of the top end of the outer bag 1, which is distant from the juice outlet 11. As shown in FIG. 1, the weight hang hole is a round hole. The round hole allows the user to conveniently weigh ingredients in the juicing bag and obtain a proper amount of juice according to the user's demand. This design is configured to ensure sufficient nutrient intake by the user and can also avoid waste.

Also, two hang holes 12 are at the welded area of the top of the outer bag 1 that is distant from the juice outlet 11. The two hang holes 12 are on opposite sides of the weight hang hole 13, respectively. One of the hang holes 12 is racetrack-shaped and the other hang hole is round. Compared with the round hang hole, the racetrack-shaped hole has more adjustment space. Thus, the hang holes 12 can be suitable for external hangers (not shown) with different spacing. This design facilitates the placement of the ingredients, and can also improve adaptability.

The inner filter bag 2 is in the approximately sealed cavity between the two layers of the outer bag 1. As shown in FIG. 1, the inner filter bag 2 is close to the bottom of the outer bag 1 (i.e., the end of the outer bag 1 that the juice outlet 11 is associated with). This design provides more space for fruit and allows a user to put more fruit into the juicing bag.

In some embodiment, the inner filter bag 2 has a U-shaped cross-section. The bottom of the cross-section of the inner filter bag 2 faces the juice outlet 11, and the opening of the inner filter bag 2 faces the top of the outer bag 1, i.e., the side where the sealing strip 3 is. The top edge of the inner filter bag 2 is seal-welded with the inner wall of the outer bag 1 through the top edge welding part 21, and the two side edges of the inner filter bag 2 are seal-welded with the inner wall of the outer bag 1 through the side edge welding parts 22, which ensures that, during the process of squeezing the ingredients, pulp of the fruit does not enter the juice outlet 11 without passing through the inner filter bag 2, thereby ensuring that the juice from the juice outlet 11 is purer and has less impurities.

The diversion line 4 is enclosed in the cavity of the outer bag 1 and between the bottom of the inner filter bag 2 and the juice outlet 11. The diversion line 4 is welded onto the front layer and back layer of the outer bag 1, respectively. The length of the diversion line 4 is smaller than the width of the cavity of the outer bag 1, which ensures that the juice flows into the juice outlet 11 through the gaps between the two sides of the diversion line 4 and the outer bag wall after passing through the inner filter bag 2. Accordingly, it prevents too much juice from directly flushing out of the juice outlet 11 and sputtering onto the juicer, so that it avoids excessive additional burden of subsequent cleaning.

The leak-proof seal 5 is located where the juice outlet 11 connects to the cavity of the outer bag 1. The leak-proof seal 5 is welded to the front and back layers of the outer bag 1. The two ends of the leak-proof seal 5 are further welded with the wall of the outer bag 1 at the juice outlet 11 of the outer bag 1. The leak-proof seal 5 is associated with a pressure limit. When the leak-proof seal is under a pressure that is lower than the pressure limit, the leak-proof seal 5 will not be opened. When the leak-proof seal is under a pressure that is higher than the pressure limit, the leak-proof seal 5 will be opened, allowing the juice to flow out through the juice outlet 11. Thus, when a user puts fruit including liquid into the cavity of the outer bag 1, the liquid, after passing through the inner filter bag 2, will not flow out through the juice outlet 11 before juicing begins. This prevents the liquid from sputtering out from the juicing bag before juicing and impacting the entire juicing process.

In some embodiments, a user may carry out an entire juicing process in the following steps: Hanging the outer bag 1 on an external hanger (not shown) by using the hang hole 12 to make the juice outlet 11 in the outer bag 1 to face downward. Manually opening the sealing strip 3 located above the cavity of the outer bag 1. Adding fruit into the cavity of the outer bag 1 and then weighing the fruit by using the weight hang hole 13 in the outer bag 1. Adjusting weight of the fruit based on preference of the user. Sealing the bag with the sealing strip 3 after the adjustment. Putting the outer bag 1 into a juicer to squeeze out the juice of the fruit. The juice, while passing through the inner filter bag 2, is filtered by the inner filter bag 2. The juice then flows along the diversion line 4, through the gaps between the two sides of the diversion line 4 and the side edges of the outer bag 1, and into the juice outlet 11. Due to the squeezing of the juicer, the leak-proof seal 5 is under a pressure higher than its pressure limit and the leak-proof seal 5 opens. Accordingly, the filtered juice flows out through the juice outlet 11, thereby completing the entire juicing process.

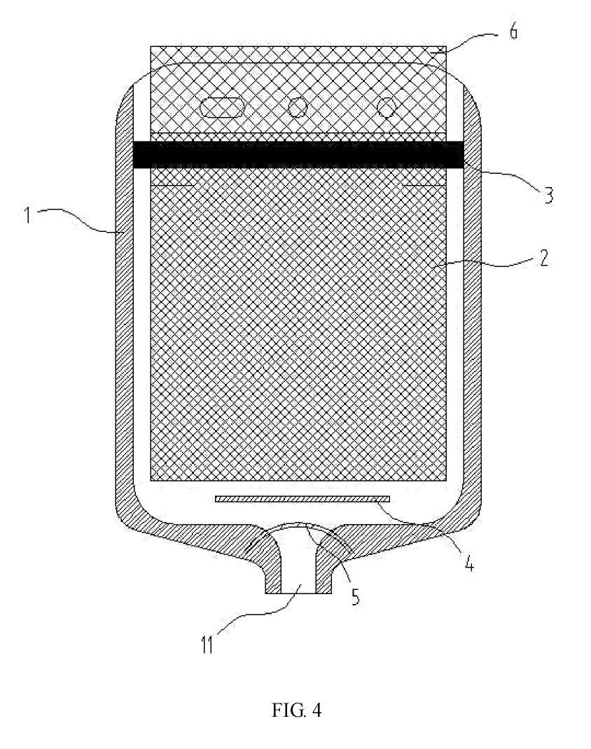

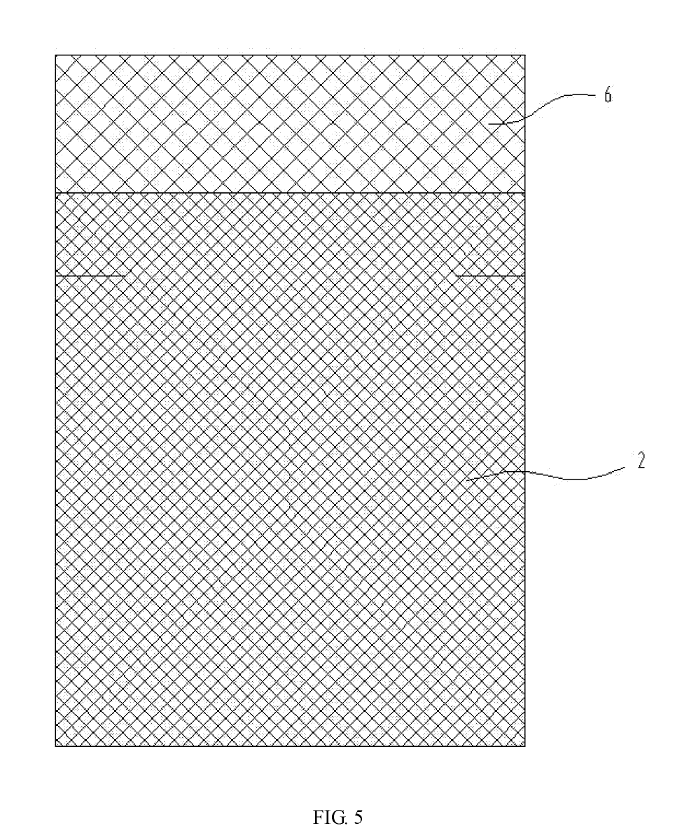

### Embodiment 2: Referring to FIG. 4 and FIG. 5

FIG. 4 is a diagram of another juicing bag, in accordance with the invention. FIG. 5 is a diagram of an inner filter bag in the juicing bag in FIG. 4, in accordance with the invention. The juicing bag in FIG. 4 includes an outer bag 1, an inner filter bag 2, a sealing strip 3, a diversion line 4, a leak-proof seal 5 and a seal flap 6. In other embodiments, the juicing bag may include additional, fewer or different components.

In some embodiments, the inner filter bag 2 is independent. The size of the inner filter bag 2 is smaller than the size of the cavity of the outer bag 1. The two side edges of the inner filter bag 2 are each independently seal-welded. The bottom edge of the inner filter bag 2 is independently welded and the top edge of the inner filter bag 2 is open, forming a bag.

The inner filter bag 2 includes two filter layers, a front filter layer and a back filter layer. At the opening of the inner filter bag 2, one of the filter layers extends beyond the opening of the inner filter bag 2. The filter layer is the seal flap 6. The seal flap 6 can be folded along the outline of the opening of the inner filter bag 2, and can be folded from this filter layer of the inner filter bag 2 onto the other filter layer of the inner filter bag 2, ensuring that fruit in the inner filter bag 2 does not leak from the inner filter bag 2 during juicing.

The inner filter bag 2 can be put into and taken out from the cavity of the outer bag 1. When using the juicing bag of FIG. 4, a user may take the inner filter bag 2 out from the outer bag 1, open the seal flap 6 of the inner filter bag 2, and put fruit to be juiced through the opening of the inner filter bag 2. After putting in the fruit, the user may seal the opening of the inner filter bag 2 by folding the seal flap 6. Then the user may put the inner filter bag 2 in the cavity of the outer bag 1 in order to juice the fruit. After the juicing is completed, the user may take the inner filter bag 2 out from the cavity of the outer bag 1, clean the inner filter bag 2 and put the inner filter bag 2 back into the cavity of the outer bag 1. Accordingly, the inner filter bag 2 can be reused. Cost of juicing is decreased.

As a preferred embodiment, the leak-proof seal 5 is located at the juice outlet 11. Also, the leak-proof seal 5 has a shape of arc. The concave side of the leak-proof seal 5 faces the inner filter bag 2. This ensures that the leak-proof seal 5 is associated with a pressure limit and cannot be opened when it is under a pressure lower than the pressure limit.

As a preferred embodiment, the outer bag 1 is made of a food-grade waterproof, pressure-resistant and sealable material, and the inner filter bag 2 is made of food-grade filter layers. It ensures that the juice is heath and harmless. Also, the juicing bag can be sealed better and safer while ensuring that the juice is healthy and harmless.

The juicing bag provided by this embodiment comprises: an outer bag 1, an inner filter bag 2 and a sealing strip 3. The outer bag 1 has a front layer and a back layer. The edges of the outer bag 1 are seal-welded. A juice outlet 11 is associated with one end (e.g., the bottom) of the outer bag 1. The inner filter bag 2 is enclosed in the outer bag 1 and between the front layer and the back layer of the outer bag 1, and has a U-shaped cross-section. The bottom of the cross-section of the inner filter bag 2 faces the juice outlet 11 of the outer bag 1. The top edge and both side edges of the inner filter bag 2 are seal-welded with an inner wall of the outer bag 1. The sealing strip 3 is associated with the outer bag 1 and is distant from the end where the juice outlet 11 is associated with the outer bag 1. The sealing strip 3 can be opened and closed freely. A diversion line 4 is between the inner filter bag 2 and the juice outlet 11. A leak-proof seal 5 is between the diversion line 4 and the juice outlet 11. Therefore, the structure design is reasonable and the layout is compact.

The combination of the outer bag 1 and the inner filter bag 2 enables juicing and filtering and ensures the juicer remains clean during the juicing process. A user does not have to clean the juicer after the juicing process. Fruit can be added through the sealing strip 3 associated with the outer bag 1, which facilitates the addition of the fruit. Also, the sealing strip is configured for a sealing effect during juicing to prevent sputtering of the juice. With the diversion line 4 between the inner filter bag 2 and the juice outlet 11, the juice squeezed out in the inner filter bag 2 can be guided towards the two sides of the outer bag 1 and then flows to the juice outlet 11. The diversion of the juice prevents the juice from flushing out from the juice outlet 11 and sputtering onto the juicer. Thus, it avoids the need to clean the juicer after the juicing process. The leak-proof seal 5 between the diversion line 4 and the juice outlet 11 ensures that liquid does not flow out from the juicing bag before juicing begins so that the normal use of the juicer will not be impacted. An end of the outer bag 1 that is distant from the juice outlet 11 (e.g, the top of the outer bag 1) includes a weight hang hole 13. The weight hang hole 13 is configured to facilitate addition of a proper amount of fruit, e.g., an amount meeting needs of the user, and avoid waste. Also, the end of the outer bag 1 that is distant from the juice outlet 11 can include hang holes 12 to facilitate addition of fruit by the user.

The embodiments described above are preferred embodiments of the invention, which are not intended to limit the embodiments and protection scope of the present invention. For a person skilled in the art, it should be appreciated that all the solutions obtained by equivalent substitutions and obvious variations made by using the disclosure in the specification and the drawings should be covered in the protection scope of the present invention.

What is claimed is:

1. A juicing bag comprising:
an outer bag comprising a front layer and a back layer, wherein an edge of the outer bag is seal welded and is associated with a juice outlet;
an inner filter bag enclosed between the front layer and the back layer of the outer bag, a top edge and both side edges of the inner filter bag seal-welded with an inner wall of the outer bag; and
a sealing strip associated with the outer bag, wherein the sealing strip is distant from the end of the outer bag that the juice outlet is associated and the sealing strip can be opened and closed.

2. The juicing bag of claim 1 further comprising two hang holes located at one end of the outer bag that is distant from the juice outlet, wherein one of the hang holes is racetrack shaped and the other hang hole is round.

3. The juicing bag of claim 1 further comprising a weight hang hole located at one end of the outer bag that is distant from the juice outlet.

4. The juicing bag of claim 1 further comprising a diversion line connecting the front and back layers of the outer bag between the inner filter bag and the juice outlet, wherein the diversion line is configured to guide juice to divert to both sides of the outer bag and then to the juice outlet.

5. The juicing bag of claim 4 further comprising a leak-proof seal located between the diversion line and the juice outlet, the leak-proof seal configured to prevent flow of juice out of the juicing bag when the leak-proof seal is below a pressure limit.

6. The juicing bag of claim 5, wherein the leak-proof seal is associated with a pressure limit and the leak-proof seal is configured to remain closed when it is under a pressure lower than the pressure limit.

7. The juicing bag of claim 1, wherein the inner filter bag is made of a food-grade material.

8. The juicing bag of claim 1, wherein the outer bag is made of a food-grade, waterproof, pressure-resistant, and sealable material.

9. The juicing bag of claim 1, wherein a cross-section of the inner filter bag is U-shaped and the bottom of the cross-section faces the juice outlet.

10. A juicing bag comprising:
an outer bag comprising a front layer and a back layer, wherein an edge of the outer bag is seal-welded and is associated with a juice outlet;
an inner filter bag enclosed between the front layer and the back layer of the outer bag, both sides and a bottom edge of the inner filter bag each independently seal-welded, wherein the inner filter bag is detachably associated with the outer bag; and
a sealing strip associated with the outer bag, wherein the sealing strip is distant from the end of the outer bag that the juice outlet is associated and the sealing strip can be opened and closed.

11. The juicing bag of claim 10 further comprising two hang holes located at one end of the outer bag that is distant from the juice outlet, wherein one of the hang holes is racetrack shaped and the other hang hole is round.

12. The juicing bag of claim 10 further comprising a weight hang hole located at the end of the outer bag where the hang holes are located.

13. The juicing bag of claim 10 further comprising a diversion line connecting the front and back layers of the outer bag between the inner filter bag and the juice outlet, wherein the diversion line is configured to guide juice to divert to both sides of the outer bag and then to the juice outlet.

14. The juicing bag of claim 13 further comprising a leak-proof seal located between the diversion line and the juice outlet, the leak-proof seal configured to prevent flow of juice out of the juicing bag when the leak-proof seal is below a pressure limit.

15. The juicing bag of claim 14, wherein the leak-proof seal is associated with a pressure limit and the leak-proof seal is configured to remain closed when it is under a pressure lower than the pressure limit.

16. The juicing bag of claim 10, wherein the inner filter bag is made of a food-grade material.

17. The juicing bag of claim 10, wherein the outer bag is made of a food-grade, waterproof, pressure-resistant, and sealable material.

18. The juicing bag of claim 10, wherein a cross-section of the inner filter bag is U-shaped and the bottom of the cross-section faces the juice outlet.

19. The juicing bag of claim 10, wherein the inner filter bag comprises two filter layers, one of the filter layers of the inner filter bag is associated with a seal flap extending beyond an opening of the inner filter bag, wherein the seal flap can be folded over the other filter layer to close the opening of the inner filter bag.
